(19) United States
(12) Patent Application Publication
(10) Pub. No.: US 2026/0336402 A1
(43) Pub. Date: Oct. 29, 2026

(54) LUMINANCE CONTROL IN AUGMENTED REALITY HEAD UP DISPLAY

(71) Applicant: GM Global Technology Operations LLC, Detroit, MI (US)

(72) Inventors: Thomas A. Seder, Fraser, MI (US); Omer Tsimhoni, Bloomfield Hills, MI (US); Kai-Han Chang, Farmington Hills, MI (US); Guy N. Kennerly, Southfield, MI (US)

(21) Appl. No.: 19/187,204

(22) Filed: Apr. 23, 2025

(51) Int. Cl. B60K 35/234; B60K 35/10; B60K 35/81; B60K 35/85; B60K 35/90

(52) U.S. Cl. CPC B60K 35/234; B60K 35/10; B60K 35/81; B60K 35/85; B60K 35/90; B60K 2360/349; B60K 2360/5899

(57) ABSTRACT

A system for controlling luminance contrast of an image displayed by an augmented reality head up display (AR-HUD) for a vehicle includes an AR-HUD adapted to display an image, wherein the image appears, to an occupant within the vehicle, painted onto a first road segment within an AR-HUD field of view, and a forward-looking camera adapted to measure luminance properties of a second road segment in front of the first road segment beyond the AR-HUD FOV, the system adapted to calculate a target image luminance contrast for the image based on the measured luminance properties of the second road segment, and adjust the luminance contrast of the image to the calculated target image luminance contrast, wherein, as the vehicle moves forward and the image appears painted onto the second road segment within the AR-HUD FOV in front of the vehicle, the contrast of the image is adjusted to the calculated target image luminance contrast.

### INTRODUCTION

The present disclosure relates to control of luminance of an image displayed by an augmented reality head up display (AR-HUD). Head up displays have become common in modern automobiles. An AR-HUD projects useful information, such as speed and navigation information, onto an inner surface of a windshield of a vehicle and into the driver's field of view, wherein the image appears painted onto the road surface in front of the vehicle. This avoids forcing the driver to look away from the road to receive such information. This reduces driver distractions and keeps the driver's eyes on the road. A contrast of the image displayed by an AR-HUD determines how clearly an occupant within the vehicle will be able to see the displayed image against varying backgrounds.

While current AR-HUD systems achieve their intended purpose, there is a need for a new and improved system and method of controlling contrast of an image displayed by an AR-HUD within a vehicle using a forward looking camera to measure luminance properties of the roadway ahead of where the image is currently displayed and adjusting contrast of the image to maintain a consistent contrast ratio as the vehicle moves.

### SUMMARY

According to several aspects of the present disclosure, a method of controlling luminance contrast of an image displayed by an augmented reality head-up-display (AR-HUD) within a vehicle includes displaying, with an AR-HUD in communication with a system controller, an image onto an inner surface of a windshield of the vehicle, wherein the image appears, to an occupant within the vehicle, painted onto a first road segment within an AR-HUD field of view (FOV) in front of the vehicle, measuring, with a forward-looking camera in communication with the system controller, luminance properties of a second road segment in front of the first road segment beyond the AR-HUD FOV, calculating, with the system controller, a target image luminance contrast for the image based on the measured luminance properties of the second road segment, and adjusting the brightness of the image to meet the calculated target image luminance contrast, wherein, as the vehicle moves forward and the image displayed appears painted onto the second road segment within the AR-HUD FOV in front of the vehicle, the brightness of the image is adjusted to meet the calculated target image luminance contrast.

According to another aspect, the displaying, with the AR-HUD in communication with the system controller, the image onto the inner surface of the windshield of the vehicle, wherein the image appears, to the occupant within the vehicle, painted onto the first road segment within the AR-HUD FOV in front of the vehicle further includes displaying, with the AR-HUD in communication with the system controller, the image onto the inner surface of the windshield of the vehicle, wherein the image appears, to the occupant within the vehicle, painted onto the first road segment within the AR-HUD FOV extending from approximately twenty-five meters in front of the vehicle to approximately ninety meters in front of the vehicle.

According to another aspect, the measuring, with the forward-looking camera in communication with the system controller, luminance properties of the second road segment in front of the first road segment beyond the AR-HUD FOV further includes calculating a distance that the second road segment is spaced in front of the AR-HUD FOV based on system latency, and measuring, with the forward-looking camera in communication with the system controller, luminance properties of the second road segment that is spaced the calculated distance in front of the AR-HUD FOV, such that as the vehicle moves forward and the image displayed appears, to the occupant, painted onto the second road segment within the AR-HUD FOV, the brightness of the image is adjusted to meet the calculated target image luminance contrast.

According to another aspect, the measuring, with the forward-looking camera in communication with the system controller, luminance properties of the second road segment in front of the first road segment beyond the AR-HUD FOV further includes calculating a distance that the second road segment is spaced in front of the AR-HUD FOV based on a speed of the vehicle, and measuring, with the forward-looking camera in communication with the system controller, luminance properties of the second road segment that is spaced the calculated distance in front of the AR-HUD FOV, such that as the vehicle moves forward and the image displayed appears, to the occupant, painted onto the second road segment within the AR-HUD FOV, the brightness of the image is adjusted to the calculated target image contrast.

According to another aspect, the measuring, with the forward-looking camera in communication with the system controller, luminance properties of the second road segment in front of the first road segment beyond the AR-HUD FOV further includes calculating a distance that the second road segment is spaced in front of the AR-HUD FOV and a lateral position of the second road segment based on a speed of the vehicle and a trajectory of the vehicle, and measuring, with the forward-looking camera in communication with the system controller, luminance properties of the second road segment spaced at the calculated distance and lateral position in front of the AR-HUD FOV.

According to another aspect, the calculating a distance that the second road segment is spaced in front of the AR-HUD FOV and a lateral position of the second road segment based on a speed of the vehicle and a trajectory of the vehicle further includes receiving, with the system controller, data related to the speed of the vehicle from a speedometer of the vehicle, and data related to the trajectory of the vehicle from a navigation system of the vehicle and a steering angle sensor of the vehicle.

According to another aspect, the measuring, with the forward-looking camera in communication with the system controller, luminance properties of the second road segment in front of the first road segment beyond the AR-HUD FOV further includes selecting, from a first look-up-table, a pixel map that maps the location of the second road segment relative to the AR-HUD FOV based on a speed of the vehicle and a trajectory of the vehicle, wherein the first look-up-table includes a plurality of pixel maps that map the location of the second road segment relative to the AR-HUD FOV at various vehicle speeds and vehicle trajectories, such that as the vehicle moves forward and the image displayed appears, to the occupant, painted onto the second road segment within the AR-HUD FOV, the brightness of the image is adjusted to meet the calculated target image luminance contrast, and measuring, with the forward-looking camera in communication with the system controller, luminance properties of the second road segment based on the selected pixel map.

According to another aspect, the adjusting the luminance contrast of the image to the calculated target image contrast, wherein, as the vehicle moves forward and the image displayed appears painted onto the second road segment within the AR-HUD FOV in front of the vehicle, the brightness of the image is adjusted to meet the calculated target image luminance contrast further includes adjusting the brightness of the image by adjusting, individually, each pixel within the image, such that the displayed image appears, to the occupant, at the calculated target luminance contrast, across the entire image, when luminance properties vary across the second road segment.

According to another aspect, the calculating, with the system controller, a target image luminance contrast for the image based on the measured luminance properties of the second road segment further includes selecting, from a second look-up-table, the calculated target image luminance contrast based on the measured luminance properties of the second road segment, wherein the second look-up-table includes a plurality of calculated target image luminance contrast values for various luminance properties of the second road segment.

According to another aspect, the adjusting the brightness of the image to meet the calculated target image luminance contrast, wherein, as the vehicle moves forward and the image displayed appears painted onto the second road segment within the AR-HUD FOV in front of the vehicle, the brightness of the image is adjusted to the calculated target image luminance contrast further includes gradually adjusting the brightness of the image to the calculated target image.

According to another aspect, the adjusting the brightness of the image to the calculated target image luminance contrast, wherein, as the vehicle moves forward and the image displayed appears painted onto the second road segment within the AR-HUD FOV in front of the vehicle, the brightness of the image is adjusted to the calculated target image luminance contrast further includes dampening brightness adjustments as the vehicle travels through alternating conditions.

According to another aspect, the measuring, with the forward-looking camera in communication with the system controller, luminance properties of the second road segment in front of the first road segment beyond the AR-HUD FOV further includes measuring, with the forward-looking camera, chromatic properties of the second road segment, and the adjusting the brightness of the image to meet the calculated target image luminance contrast, wherein, as the vehicle moves forward and the image displayed appears painted onto the second road segment within the AR-HUD FOV in front of the vehicle, the contrast of the image is adjusted to the calculated target image luminance contrast further includes adjusting chromatic properties of the image based on the chromatic properties of the second road segment.

According to another aspect, the method further includes monitoring, with an occupant monitoring system, the occupant's eyes, wherein, the calculating, with the system controller, a target image luminance contrast for the image based on the measured luminance properties of the second road segment further includes calculating, with the system controller, a target image luminance contrast for the image based on the measured luminance properties of the second road segment and pupil characteristics of the eyes of the occupant.

According to several aspects of the present disclosure, a system for controlling luminance of an image displayed by an augmented reality head up display (AR-HUD) for a vehicle includes an AR-HUD in communication with a system controller and adapted to display an image onto an inner surface of a windshield of the vehicle, wherein the image appears, to an occupant within the vehicle, painted onto a first road segment within an AR-HUD field of view (FOV) that extends from approximately twenty-five meters in front of the vehicle to approximately ninety meters in front of the vehicle, and a forward-looking camera in communication with the system controller and adapted to measure luminance properties of a second road segment in front of the first road segment beyond the AR-HUD FOV, the system controller adapted to calculate a target image luminance contrast for the image based on the measured luminance properties of the second road segment, and adjust the brightness of the image to meet the calculated target image luminance contrast, wherein, as the vehicle moves forward and the image displayed appears painted onto the second road segment within the AR-HUD FOV in front of the vehicle, the brightness of the image is adjusted to meet the calculated target image luminance contrast.

According to another aspect, the system controller is adapted to receive data related to a speed of the vehicle from a speedometer within the vehicle, and data related to the trajectory of the vehicle from a navigation system of the vehicle and a steering position sensor of the vehicle, and calculate a distance that the second road segment is spaced in front of the AR-HUD FOV and a lateral position of the second road segment based on at least one of system latency, vehicle speed or vehicle trajectory.

According to another aspect, the system controller is further adapted to select, from a first look-up-table stored therein, a pixel map that maps the location of the second road segment relative to the AR-HUD FOV based on a speed of the vehicle and a trajectory of the vehicle, wherein the look-up-table includes a plurality of pixel maps that map the location of the second road segment relative to the AR-HUD FOV at various vehicle speeds and vehicle trajectories, and select, from a look-up-table stored therein, the calculated target image luminance contrast based on the measured luminance properties of the second road segment, wherein the second look-up-table includes a plurality of calculated target image luminance contrast values for various luminance properties of the second road segment.

According to another aspect, the system controller is adapted to adjust the brightness of the image by adjusting, individually, each pixel within the image, such that the displayed image appears, to the occupant, at the calculated target image luminance contrast, across the entire image, when luminance properties vary across the second road segment.

According to another aspect, the system controller is further adapted to gradually adjusting the brightness of the image to meet the calculated target image luminance contrast, dampen brightness adjustments as the vehicle travels through alternating conditions, and measure, with the forward-looking camera, chromatic properties of the second road segment and adjust chromatic properties of the image based on the chromatic properties of the second road segment.

According to another aspect, the system further includes an occupant monitoring system adapted to monitor the eyes of the occupant, wherein, the system controller is further adapted to calculate the target image luminance contrast for the image based on the measured luminance properties of the second road segment and pupil characteristics of the eyes of the occupant.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle having a system in accordance with an exemplary embodiment of the present disclosure;

FIG. 2 is a schematic illustration of the system according to an exemplary embodiment;

FIG. 3 is a schematic illustration of an exemplary embodiment of an augmented reality head up display of the system;

FIG. 4 is a schematic illustration of another exemplary embodiment of an augmented reality head up display of the system;

FIG. 5 is a side schematic view of a vehicle having a system in accordance with the present disclosure wherein the augmented reality head up display has a field of view that defines a first road segment where a displayed image appears to an occupant within the vehicle;

FIG. 6 is a representation of a windshield of a vehicle, wherein the first road segment and a second road segment are visible in front of the vehicle and the image is displayed within a far image plane;

FIG. 7 is a side schematic view similar to FIG. 5, wherein a forward-looking camera of the system has a field of view that includes a second road segment in front of the first road segment and beyond the field of view of the augmented reality head up display;

FIG. 8A is a side schematic view wherein the vehicle is approaching a tunnel, the first road segment is not yet within the tunnel but the second road segment is within the tunnel;

FIG. 8B is a side schematic view wherein the vehicle is approaching the tunnel, the first road segment and the second road segment are within the tunnel;

FIG. 8C is a side schematic view wherein the vehicle is within the tunnel and about to exit the tunnel, the first road segment is still within the tunnel and the second road segment is outside of the tunnel;

FIG. 8D is a side schematic view wherein the vehicle is within the tunnel and about to exit the tunnel, the first and second road segments are outside of the tunnel;

FIG. 9A is a representation of the windshield of the vehicle similar to FIG. 6, wherein the calculated distance between the first road segment and the second road segment is larger than the calculated distance between the first road segment and the second road segment in FIG. 6;

FIG. 9B is a representation of the windshield of the vehicle similar to FIG. 9A, wherein the calculated distance between the first road segment and the second road segment is larger than the calculated distance between the first road segment and the second road segment in FIG. 9A;

FIG. 10A is a representation of the windshield of the vehicle similar to FIG. 6, wherein the second road segment is positioned laterally to the right of the first road segment;

FIG. 10B is a representation of the windshield of the vehicle similar to FIG. 6, wherein the second road segment is positioned laterally to the left of the first road segment;

FIG. 11A is a schematic representation of a pixel map corresponding to the situation illustrated in FIG. 10A;

FIG. 11B is a schematic representation of a pixel map corresponding to the situation illustrated in FIG. 10B;

FIG. 12A is a representation of the windshield wherein background luminance for each of a displayed left chevron, a right chevron and a directional arrow are uniform, and thus, the contrast of the displayed left chevron, right chevron and directional arrow are uniform and the left chevron, the right chevron and the directional arrow all appear to the occupant with uniform contrast;

FIG. 12B is a representation of the windshield similar to FIG. 12A, wherein background luminance for the left chevron and a left side of the directional arrow are different than background luminance for the right chevron and a right side of the directional arrow, and the contrast of the displayed left chevron, right chevron and directional arrow are uniform so the left chevron and the left side of the directional arrow appear to the occupant with different contrast than the right chevron and the right side of the directional arrow;

FIG. 12C is a representation of the windshield similar to FIG. 12A, wherein background luminance for the left chevron and a left side of the directional arrow are different than background luminance for the right chevron and the right side of the directional arrow, and the target contrast for each pixel of the left chevron, right chevron, and right and left sides of the directional arrow are individually calculated based on background luminance and the left chevron, the right chevron and the directional arrow all appear to the occupant with uniform contrast;

FIG. 13 is a representation of the windshield similar to FIG. 6, wherein streetlamps line the roadway in front of the vehicle; and

FIG. 14 is a schematic flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

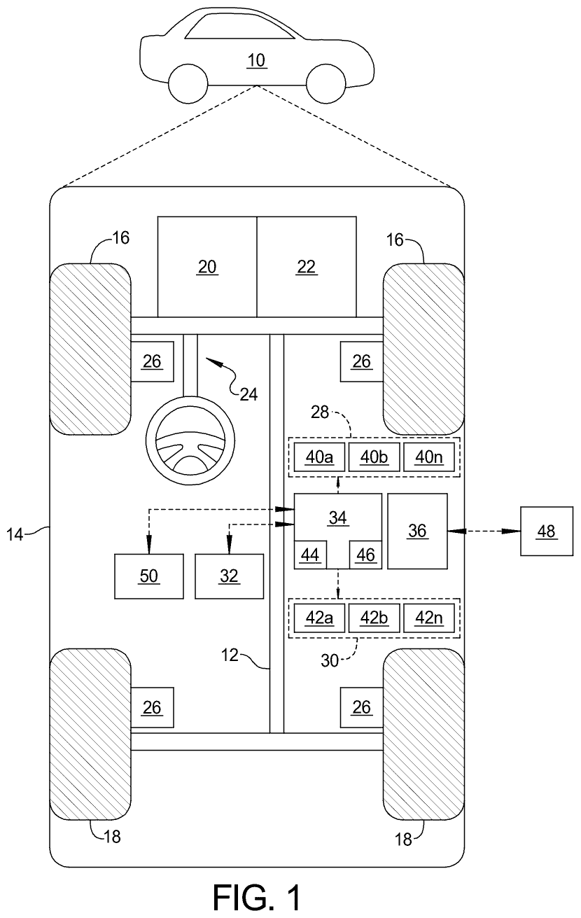

In accordance with an exemplary embodiment, FIG. 1 shows a vehicle 10 with an associated system 50 for controlling luminance of an image 82 displayed by an augmented reality head up display (AR-HUD) 64. In general, the system 50 works in conjunction with other systems within the vehicle 10 to display various information and infotainment content for the driver. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 50 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to lower levels of automation (Level zero to Level three). Aspects of the present disclosure are particularly applicable to level two or level three automation systems, and to vehicle s with any combinations of these levels of automation, for example, when a vehicle operates at level zero automation and later changed to level two automation during the same trip.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of sensing devices 40a-40n is capable of measuring distances in the environment surrounding the vehicle 10.

In a non-limiting example wherein the plurality of sensing devices 40a-40n includes a camera, the plurality of sensing devices 40a-40n measures distances using an image processing algorithm configured to process images from the camera and determine distances between objects. In another non-limiting example, the plurality of vehicle sensors 40a-40n includes a stereoscopic camera having distance measurement capabilities. In one example, at least one of the plurality of sensing devices 40a-40n is affixed inside of the vehicle 10, for example, in a headliner of the vehicle 10, having a view through the windshield of the vehicle 10. In another example, at least one of the plurality of sensing devices 40a-40n is a camera affixed outside of the vehicle 10, for example, on a roof of the vehicle 10, having a view of the environment surrounding the vehicle 10 and adapted to collect information (images) related to the environment outside the vehicle 10. It should be understood that various additional types of sensing devices, such as, for example, LiDAR sensors, ultrasonic ranging sensors, radar sensors, and/or time-of-flight sensors are within the scope of the present disclosure. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the vehicle controller 34 are embodied in a trajectory planning system and, when executed by the at least one data processor 44, generates a trajectory output that addresses kinematic and dynamic constraints of the environment. For example, the instructions receive as input process sensor and map data. The instructions perform a graph-based approach with a customized cost function to handle different road scenarios in both urban and highway roads.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

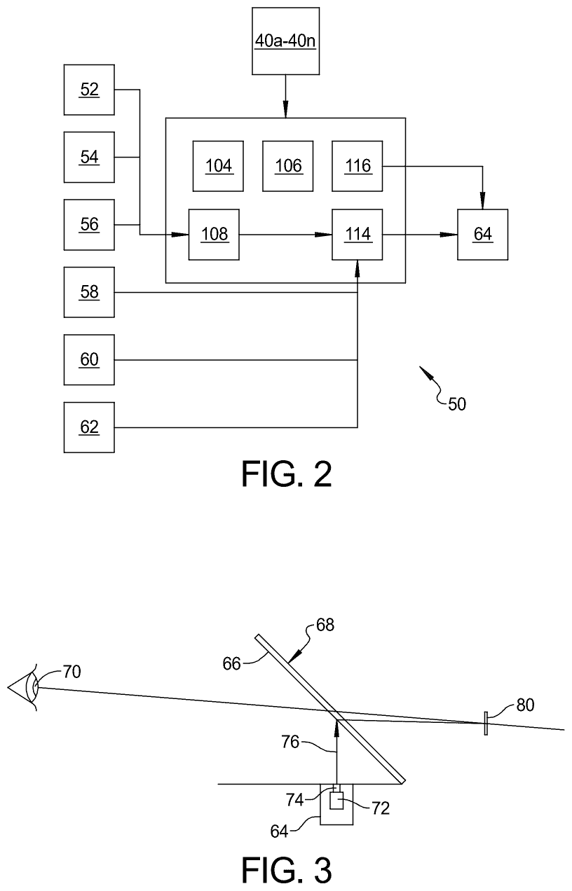

Referring to FIG. 2 a schematic diagram of the system 50 is shown. The system 50 includes a system controller 34A in communication with the plurality of sensing devices (onboard sensors) 40a-40n. The system controller 34A may be the vehicle controller 34, or the system controller 34A may be a separate controller in communication with the vehicle controller 34. In addition to the plurality of onboard sensors 40a-40n, the system controller 34A is in communication with a forward-looking camera 52, an occupant monitoring system 54 having at least one camera and adapted to track a position of an occupant's head and eyes 70 as well as the orientation or gaze location of the occupant's eyes 70 and a state (dilated, constricted) of the occupant's pupils. The plurality of sensors further includes at least one ambient light sensor 56 adapted to gather information related to luminance properties at the vehicle 10. The system controller 34A is further in communication with a navigation system 58 of the vehicle 10, a steering wheel position sensor 60 and a speedometer 62.

The system controller 34A is further in communication with the wireless communication module 36. The wireless communication module 36 is located within the system controller 34A and is adapted to allow wireless communication between the vehicle 10 and other vehicles or other external sources. The system controller 34A is adapted to collect information from databases via a wireless data communication network over wireless communication channels such as a WLAN, 4G/LTE or 5G network, or the like. Such databases can be communicated with directly via the internet, or may be cloud-based databases. Information that may be collected by the system controller 34A from such external sources 48 includes, but is not limited to road and highway databases maintained by the department of transportation, a global positioning system, the internet, other vehicles via V2V communication networks, traffic information sources, vehicle-based support systems such as OnStar, etc.

The system 50 further includes an augmented reality head up display system (AR-HUD) 64 in communication with the system controller 34A and adapted to project images onto an inner surface 66 of a windshield 68 of the vehicle 10. Images projected by the AR-HUD 64 are reflected, by the inner surface 66 of the windshield 68 to the eyes 70 of the occupant within the vehicle 10, and appear, to the occupant, painted onto a surface of the roadway in front of the vehicle 10.

Referring to FIG. 3, in an exemplary embodiment, the AR-HUD 64 includes a projection module 72 including at least one light source 74 that is adapted to project an image upon the inner surface 66 of the windshield 68 of the vehicle 10. As described herein, the at least one light source 74 comprises a laser, however, it should be understood that the at least one light source 74 may be other known types of light sources used in head-up display systems. In an exemplary embodiment, the projection module 72 of the AR-HUD 64 is a holographic projection module and includes an exit pupil replicator. The holographic image is projected into the exit pupil replicator and then propagates inside the exit pupil replicator and is extracted multiple times before being projected upward to the inner surface 66 of the windshield 68, as indicated by arrow 76. The re-circulation of the light several times within the exit pupil replicator expands the pupil so the viewer can see the holographic image from an extended eye-box. In addition to expanding the eye-box, the exit pupil replicator also magnifies the original projected image coming out of the light source 74. A spatial light modulator is positioned between the light source 74 and the exit pupil replicator. The spatial light modulator is adapted to receive the light from the light source 74, to diffract the laser light with an encoded hologram and to deliver the diffracted laser to the exit pupil replicator. As shown and described herein, the AR-HUD 64 is a holographic head-up system, however, it should be understood that the novel features of the present disclosure are applicable to other head-up display configurations.

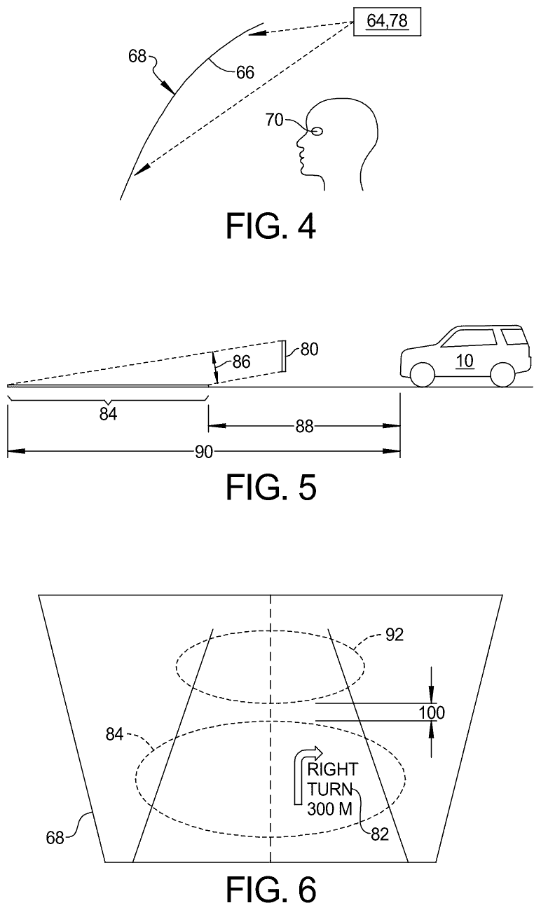

Referring to FIG. 4, in another exemplary embodiment, the AR-HUD 64 comprises a digital light projector (DLP) 78 adapted to project images onto the inner surface 66 of the windshield 68 of the vehicle 10. The DLP 78 includes a light source adapted to project an excitation light, a condensing lens adapted to focus the excitation light from the light source, a color filter (color wheel) adapted to split the focused excitation light into red, green and blue light, a shaping lens adapted to focus the excitation light passing through the color filter, a digital micro-mirror device (DMD) adapted to re-direct the excitation light, and a projection lens adapted to receive the excitation light from the DMD and project the excitation light to the inner surface 66 of the windshield 68.

The windshield 68 is equipped with features capable of displaying an image projected thereupon while remaining transparent or substantially transparent such that occupants of the vehicle 10 can clearly observe outside of the vehicle 10 through the windshield 68. It should be understood that, as depicted, the windshield 68 is in the front of the vehicle 10, other surfaces within the vehicle 10 could be used for projection, including side windows and a rear window. Additionally, the view on the front windshield 68 could be continued upon the front vehicle “A-pillars” and onto the side windows as a continuous image. The windshield 68 is both transparent and capable of displaying images projected by an excitation light. An occupant within the vehicle is able to see an arbitrary object through a substrate positioned on the windshield 68. The substrate may be transparent or substantially transparent. While the occupant sees objects through the substrate, the occupant can also see images that are created at the substrate. The substrate may be part of the windshield 68, a glass substrate, a plastic substrate, a polymer substrate, or other transparent (or substantially transparent) medium that would be appreciated by one of ordinary skill in the art. Other substrates may complement the substrate to provide for tinting, substrate protection, light filtering (e.g. filtering external ultraviolet light), and other functions. The substrate receives excitation light from the light source. The received excitation light may be absorbed by light emitting material at the substrate. When the light emitting material receives the excitation light, the light emitting material emits visible light. Accordingly, images may be created at the substrate by selectively illuminating the substrate with excitation light.

In an exemplary embodiment, the light emitting material includes transparent phosphors that are embedded into the substrate. The transparent phosphors are light emitting particles which fluoresce in response to being excited by the excitation light. In an exemplary embodiment, the transparent phosphors are red, green, and blue (RGB) phosphors, allowing full color. The use of monochrome and/or two-color phosphors is also within the scope of the present disclosure. When excitation light is absorbed by the transparent phosphors, visible light is emitted by the transparent phosphors. The excitation light is provided by the light source. Use of the substrate and light emitting material to display graphics is discussed in greater detail in U.S. application Ser. No. 17/749,464 titled “HYBRID AUGMENTED REALITY HEAD-UP DISPLAY FOR CREATING AN EDGE-TO-EDGE AUGMENTED REALITY VIEW” filed on May 20, 2022, the entire contents of which is hereby incorporated by reference.

In an exemplary embodiment, the light source is a micro-mirror array (MMA) projector (e.g. a digital light processing (DLP) projector 78). In the DLP 78, images are created by microscopically small mirrors laid out in a matrix on a semiconductor chip within the DMD. An MMA projector that outputs ultraviolet light may be similar to an MMA projector that outputs visible light, except that the color filter has light filters that are tailored to the ultraviolet light spectrum. In other embodiments, the DLP 78 is a liquid crystal display (LCD) projector. In embodiments, the DLP 78 may be a liquid crystal on silicon (LCOS) projector. In embodiments, the DLP 78 may be an analog projector (e.g. a slide film projector or a movie film projector). One of ordinary skill in the art would appreciate other types of projectors which may be used to project ultraviolet light on the substrate.

The system controller 34A includes an image generation engine 116 which includes a programmable processor including programming to monitor various inputs and determine what information is appropriate to include within the displayed image 82, and to generate appropriate text and/or graphics to include within the image 82. The image generation engine 116 includes display software and programming for translating requests to display information into graphical representations describing the information. Further, the system controller 34A and image generation engine 116 are adapted to continuously update the displayed image 82 as data is received from the occupant monitoring system 54, the at least one image capturing device and the at least on non-visual sensor (included within the plurality of onboard sensors 40a-40n), and data received via the wireless communication module 36.

The image generation engine 116 can communicate directly with various systems and components, or the image generation engine 116 can alternatively or additionally communicate over a LAN/CAN system. The image generation engine 116 utilizes information regarding the operational environment of the vehicle 10 derived from a number of inputs and includes programming to compensate for the curved and tilted surface of the windshield 68 and any other surfaces onto which images are to be projected.

Referring to FIG. 5, the AR-HUD 64 projects images that are perceived by the occupant in a far image plane 80, wherein, referring to FIG. 6, the image 82 appears, to the occupant within the vehicle 10, painted onto the surface of a first road segment 84 within an AR-HUD field of view (FOV) 86 in front of the vehicle 10. FIG. 6 is an exemplary interior view of the windshield 68, where the environment surrounding the vehicle 10 is visible through the windshield 68 and the image 82 projected by the AR-HUD 64 is perceived by the occupant overlayed onto the surface of the first road segment 84. The first road segment 84 is the portion of the road in front on the vehicle onto which the AR-HUD 64 can project the image 82. In an exemplary embodiment, the AR-HUD FOV 86 defines the first road segment 84 extending from approximately twenty-five meters in front of the vehicle 10, as indicated at 88, to approximately ninety meters in front of the vehicle 10, as indicated at 90. As shown, the image 82 includes an arrow and text indicating an upcoming right turn for the vehicle 10. It should be understood that the image 82 may be any image or text that might be displayed by an AR-HUD system.

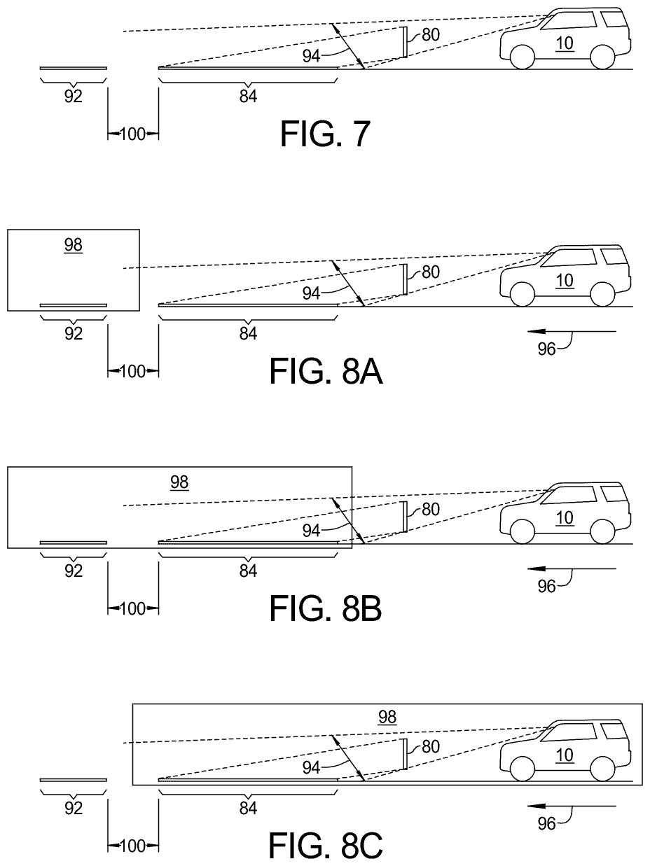

The forward-looking camera 52 is adapted to measure luminance properties of a second road segment 92 in front of the first road segment beyond the AR-HUD FOV 86. Referring to FIG. 7, the forward looking camera 52 has a FOV 94 that is wider than the AR-HUD FOV 86, allowing the forward looking camera 52 to capture images and visual data from areas beyond the AR-HUD FOV 86. Thus, the forward looking camera 52 is able to look outward in front of the vehicle 10 and in front of where the currently displayed image 82 appears to the occupant to evaluate what the luminance properties are at the second road segment 92, wherein the system controller 34A is adapted to calculate a target image luminance contrast for the image 82 based on the measured luminance properties of the second road segment 92, and adjust the luminance contrast of the image 82 to the calculated target image contrast. As the vehicle 10 moves forward and the image 82 appears overlayed onto the second road segment 92 within the AR-HUD FOV 86 in front of the vehicle 10, the luminance contrast of the image 82 is adjusted to the calculated target image luminance contrast.

The contrast or brightness of the image 82 perceived by the occupant depends upon the luminance properties of the background (the first road segment 84) and the luminance properties of the image 82 as projected by the AR-HUD 64. Prior systems utilize the ambient light sensor 56 to establish background luminance properties, however the ambient light sensor 56 is generally not aimed at the roadway (twelve to fourteen degrees above the horizon) and has a narrow field of view (approximately twelve degrees). Thus, when the luminance properties at the location on the roadway where the image is perceived (first road segment 84) differ from the luminance properties as detected by the ambient light sensor 56, such as when the vehicle 10 is entering or exiting a tunnel, or when discrete areas of varying luminance properties (“light puddles”) are present, establishing a target image contrast for the image 82 can be challenging. A target luminance contrast is the contrast between a brightness of the image 82 displayed on the inner surface of the windshield as compared to a brightness of the background. When the image 82 is being viewed within the first road segment 84, the brightness of the image 82, as perceived by the occupant, depends on the background brightness within the first road segment 84. The target luminance contrast includes the brightness characteristics of the displayed image 82 that provide brightness of the displayed image 82 that provides optimal viewing of the image by the occupant. If the luminance contrast of the displayed image 82 makes the image too bright, then the displayed image will be a distraction to the occupant, however, if the luminance contrast of the displayed image 82 makes the image too dim, then the displayed image 82 will be difficult for the occupant to see.

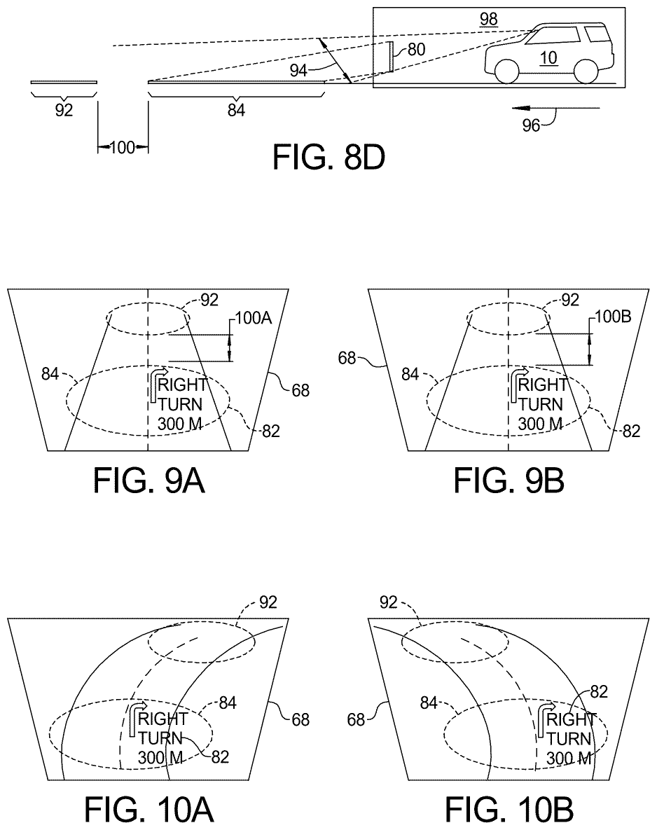

The forward-looking camera 52 allows the system 50 to look out, beyond where the image 82 is currently perceived by the occupant to pre-emptively begin making adjustments to the luminance contrast of the image 82. For example, referring to FIG. 8A, the vehicle 10 is moving, as indicated by arrow 96, toward a tunnel 98. At time T₁, the vehicle 10 is not yet in the tunnel 98 and the first road segment 84, is not yet in the tunnel 98, however, the second road segment 92 is within the tunnel 98, so the forward looking camera 52 gathers data indicating that conditions within the tunnel 98 (within the second road segment 92) are darker, and thus, the target image luminance contrast for the image 82 dictates that the brightness of the image 82 should be lower to maintain optimal perception of the image 82 by the occupant against the darker background, and the system controller 34A makes appropriate adjustments to the contrast properties of the image 82 as displayed by the AR-HUD 64.

Thus, referring to FIG. 8B, at time T₂ the vehicle 10 has moved forward so that the first road segment 84 is within the tunnel 98, and the background luminance is darker, but the system controller 34A has already initiated adjustments based on pre-emptively measuring luminance properties within the tunnel 98 with the forward-looking camera 52, so at time T₂, the system has already adjusted the displayed image 82 to the target image luminance contrast (the image 82 is displayed less bright), and the occupant perceives the image 82 against the darker background, clearly.

Referring to FIG. 8C, at time T₃, the vehicle 10 is travelling through the tunnel 98. The first road segment 84 is still within the tunnel 98, however, the second road segment 92 is now outside the tunnel 98, so the forward-looking camera 52 gathers data indicating that conditions beyond the tunnel 98 (within the second road segment 92) are once again brighter, and thus, the target image luminance contrast for the image 82 dictates that the image brightness should be higher to maintain optimal perception of the image 82 by the occupant, against the brighter background outside of the tunnel 98, and the system controller 34A makes appropriate adjustments to the contrast properties of the image 82 as displayed by the AR-HUD 64.

Thus, referring to FIG. 8D, at time T₄ the vehicle 10 has moved forward so that the first road segment 84 is now outside the tunnel 98, although the vehicle 10 is still within the tunnel 98, and the background luminance is brighter, but the system controller 34A has already initiated adjustments based on pre-emptively measuring luminance properties outside the tunnel 98 with the forward-looking camera 52, so at time T₄, the system controller 34A has already adjusted the brightness of the displayed image 82 to meet the target image luminance contrast, and the occupant perceives the image 82 clearly against the brighter background outside of the tunnel 98.

The system controller 34A takes into account latency within the system 50, the speed of the vehicle 10 and the trajectory of the vehicle 10 in determining how far in front of the first road segment 84 the second road segment 92 is positioned. System latency is the time that it actually takes the system controller 34A to perform calculations and initiate changes. Thus, going back to the example cited above, the second road segment 92 should be far enough in front of the first road segment 84 that when, at time T₁, as shown in FIG. 8A, the system controller 34A initiates adjustments to the luminance contrast of the image 82, the adjustments will be made, at time T₂, as shown in FIG. 8B. Vehicle speed also has impact on this, as, the speed of the vehicle 10 dictates how far the vehicle 10 will travel between time T₁ and time T₂. The faster the vehicle 10 is going, the further out the forward-looking camera 52 must look at the second road segment 92.

In an exemplary embodiment, the system controller 34A is adapted to receive data related to a speed of the vehicle 10 from the speedometer 62 within the vehicle 10. The system latency is a constant that is established ahead of time. The system controller 34A calculates a distance 100 that the second road segment 92 is spaced in front of the AR-HUD FOV 86 and the first road segment 84 based on system latency and vehicle speed. Referring again to FIG. 6, the second road segment 92 is spaced the calculated distance 100 in front of the first road segment 84 such that adjustments to the contrast of the image 82 based on luminance properties measured at the second road segment 92 will be applied by the time the vehicle 10 moves forward that distance.

For example, if system latency requires one second to initiate and complete adjustments to the contrast of the image 82, and the vehicle 10 is moving at fifty feet per second, then the system controller 34A will calculate the distance 100 to be fifty feet, because the vehicle 10 will travel that far in the time it takes to initiate and complete adjustments to the contrast of the image 82.

Referring to FIG. 9A, if the vehicle 10 is moving at a higher speed, one-hundred feet per second, then the forward-looking camera 52 will look further out, wherein the system controller 34A will calculate a larger distance 100A, of one-hundred feet, between the first road segment 84 and the second road segment 92, as the vehicle 10 will travel one-hundred feet in the time it takes the system 50 to initiate and complete adjustments to the contrast of the image 82. Referring to FIG. 9B, if the vehicle 10 is moving at a higher speed, one-hundred and fifty feet per second, then the forward-looking camera 52 will look further out, wherein the system controller 34A will calculate a larger distance 100B, of one-hundred and fifty feet, between the first road segment 84 and the second road segment 92, as the vehicle 10 will travel one-hundred and fifty feet in the time it takes the system 50 to initiate and complete adjustments to the contrast of the image 82.

The system controller 34A further receives data related to the trajectory of the vehicle 10 from the navigation system 58 of the vehicle 10 and the steering position sensor 60, wherein, when calculating the distance 100, the system controller 34A further calculates a lateral position of the second road segment 92. Just as with vehicle speed, the system controller 34A uses the trajectory of the vehicle 10 to determine where to gather luminance data (second road segment 92).

Referring to FIG. 10A, if data indicates that the trajectory of the vehicle 10 is moving to the right, such as when the road curves to the right, the second road segment 92 is located at the calculated distance in front of the first road segment 84, but also the second road segment is positioned to the right, following the trajectory of the vehicle 10. Correspondingly, referring to FIG. 10B, if data indicates that the trajectory of the vehicle 10 is moving to the left, such as when the road curves to the left, the second road segment 92 is located at the calculated distance 100 in front of the first road segment 84, but also the second road segment 92 is positioned to the left, following the trajectory of the vehicle 10.

Thus, the system controller 34A uses vehicle speed, system latency and vehicle trajectory to determine where the second road segment 92 is positioned relative to the first road segment 84 to ensure that the forward-looking camera is gathering luminance data from the position where the vehicle 10 will be once corresponding adjustments are made. The system controller 34A is pre-emptively initiating adjustments to the luminance contrast of the image 82 to ensure that the image 82 will be adjusted for optimum visibility by the occupant.

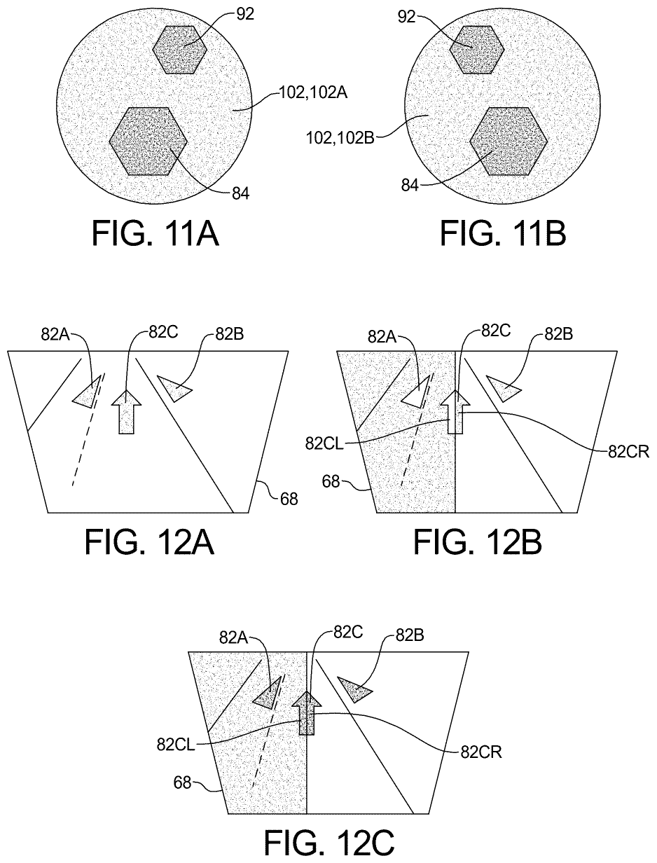

In an exemplary embodiment, the system controller 34A is adapted to select a pixel map 102 that maps the location (distance 100 and lateral position) of the location of the second road segment relative to the AR-HUD FOV and the first road segment 84, from a first look-up-table 104 stored within the system controller 34A. The first look up table 104 includes a plurality of pixel maps 102 that map the location of the second road segment 92 relative to the AR-HUD FOV 86 and the first road segment 84 at various vehicle speeds and vehicle trajectories. The first look up table 104 is created ahead of time allowing the system controller 34A to quickly access such information without having to perform calculations, reducing system latency. Referring to FIG. 11A, a pixel map 102A is shown that corresponds to the situation shown in FIG. 10A, and referring to FIG. 11B, a pixel map 102B is shown that corresponds to the situation shown in FIG. 10B.

In another exemplary embodiment, the system controller 34A includes a second look up table 106 stored therein. The second look up table includes a plurality of calculated target image luminance contrast values for various measured luminance properties of the second road segment 92. When calculating target luminance contrast and the brightness characteristics of a displayed image 82 based on the target luminance contrast, the system controller 34 applies the luminance properties gathered by the forward looking camera 52 to an algorithm which calculates the target image luminance contrast and corresponding brightness characteristics of the displayed image 82 that will meet the target image luminance contrast. The system controller 34A is adapted to select the calculated target image luminance contrast based on the measured luminance properties of the second road segment 92. The second look up table 106 is created ahead of time allowing the system controller 34A to quickly access such information without having to perform calculations in real time, reducing system latency.

The system controller 34A includes a luminance calculation module 108 that is adapted to receive data from the forward-looking camera 52, the occupant monitoring system 54 and the ambient light sensor 56 and uses this data to either calculate the target image luminance contrast for the displayed image 82 or access the second look up table 106 and use the target image luminance contrast corresponding to the measured luminance data from the forward-looking camera 52.

In an exemplary embodiment, the system controller 34A is adapted to adjust the brightness of the image 82 by adjusting, individually, each pixel within the image 82, such that the displayed image 82 appears, to the occupant, at the calculated target luminance contrast, across the entire image 82, when luminance properties vary across the second road segment 92. For example, referring to FIG. 12A, when luminance properties across the second road segment 92 are consistent, the background for the displayed image 82 is consistent. As shown, the image 82 includes a left chevron 82A, a right chevron 82B and a directional arrow 82C. All three features 82A, 82B, 82C of the image 82 have the same background luminance properties, and thus are displayed with the same brightness properties as displayed by the AR-HUD 64, based on the target image luminance contrast, and appear to the occupant with consistent brightness across the entirety of the three features 82A, 82B, 82C.

Referring to FIG. 12B, if luminance properties across the second road segment 92 vary, such as, a left side of the roadway is shaded, and a right side of the roadway is in full sunshine, then the features 82A, 82B, 82C of the image 82 will have different backgrounds, such that if the luminance properties of the image 82 from the AR-HUD 64 are uniform across the image 82, then different parts of the image 82 will appear with a different brightness to the occupant. As shown, the left chevron 82A and a left side 82CL of the directional arrow 82C have a shaded background and appear to the occupant to have different luminance contrast or brightness compared to the right chevron 82B and a right side 82CR of the directional arrow 82C which have a brighter background. Thus, the system controller 34A gathers data from the forward-looking camera 52 on a pixel by pixel basis, and establishes luminance properties for each pixel within the second road segment 92, wherein the system controller 34A selects target image luminance contrast values for each pixel of the displayed image 82 to ensure that the entire image 82 appears to the occupant with consistent contrast. Referring to FIG. 12C, even though the left chevron 82A and the left side 82CL of the directional arrow 82C have a shaded background and the right chevron 82B and the right side 82CR of the directional arrow 82C have a brighter background, the left chevron 82A, the right chevron 82C and both halves 82CL, 82CR of the directional arrow 82C appear to the occupant with consistent luminance contrast/brightness.

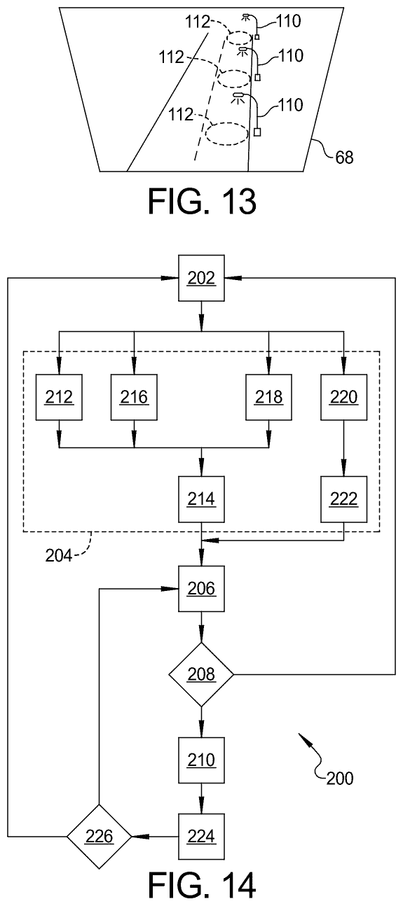

In another exemplary embodiment, the system controller 34A is further adapted to gradually adjust the contrast of the image 82 to the calculated target image luminance contrast. Thus, if the calculated target image contrast is much brighter than the current image contrast, the system controller 34A will gradually ramp up the image contrast, rather than changing the contrast instantly. For example, if the target image luminance contrast is dramatically different than current display settings, the system controller 34A will make several subtle adjustments, rather than one dramatic single adjustment. Further, the system controller 34A is adapted to dampen contrast adjustments as the vehicle 10 travels through alternating conditions. For example, referring to FIG. 13, street-lights 110 along a roadway create light puddles 112 which create rapidly alternating light and dark areas ahead of a vehicle 10 traveling along the roadway. Upon detection of such a pattern, the system controller 34A is adapted to calculate an average target image contrast and adjust the displayed image 82 to the average target image contrast for as long as the pattern continues. This avoids a situation where the system controller 34A is repeatedly switching back and forth between two different target image contrast values, which would ultimately be more inconvenient than helpful for an occupant.

The system controller 34A includes a luminance smoothing module 114 that is adapted to avoid undesirable fluctuations in the contrast of the image 82 displayed by the AR-HUD 64 as a result of varying background luminance properties, as calculated by the luminance calculation module 108. The luminance smoothing module receives current AR-HUD image contrast values as input and combines these with future expected target image contrast values, predicted by the forward-looking camera 52 and input from the navigation system 58.

In another exemplary embodiment, the system controller 34A is adapted to measure, with the forward-looking camera 52, chromatic properties of the second road segment 92 and adjust chromatic properties of the image 82 based on the chromatic properties of the second road segment 92. For example, the image may be displayed with a white color, however, if the road becomes snow covered, an occupant will not be able to see the white image 82 against a white background. Thus, the system controller 34A monitors chromatic properties of the second road segment 92 to ensure visibility of the displayed image 82 and makes changes to the color of the displayed image 82 in response to backgrounds that do not provide sufficient contrast.

In another exemplary embodiment, the system controller 34A is adapted to monitor the eyes 70 of the occupant with the occupant monitoring system 54 and to calculate the target image contrast for the image based on the measured luminance properties of the second road segment 92 and pupil characteristics of the eyes 70 of the occupant. Pupils dilate and contract based on brightness, thus, the size and changes to the size of the pupils of the occupant can be an indicator that the occupant is struggling to adapt their eyes to the brightness of the displayed image. The system controller 34A can use this data as a secondary input when calculating target image contrast values. Further, monitoring the pupils of the occupant serves as a feedback loop, wherein, lack of pupil changes is an indication that the target image contrast value that the image 82 has been adjusted to is appropriate.

Referring to FIG. 14, a method 200 of controlling contrast of an image 82 displayed by an augmented reality head-up-display (AR-HUD) 64 within a vehicle 10 includes, beginning at block 202, displaying, with an AR-HUD 64 in communication with a system controller 34A, an image 82 onto an inner surface 66 of a windshield 68 of the vehicle 10, wherein the image 82 appears, to an occupant within the vehicle 10, painted onto a first road segment 84 within an AR-HUD field of view (FOV) 86 in front of the vehicle 10, moving to block 204, measuring, with a forward-looking camera 52 in communication with the system controller 34A, luminance properties of a second road segment 92 in front of the first road segment 84 beyond the AR-HUD FOV 86, moving to block 206, calculating, with the system controller 34A, a target image contrast for the image 82 based on the measured luminance properties of the second road segment 92, and, if at block 208, the current image contrast differs from the target image contrast, then, moving to block 210, the method includes adjusting the contrast of the image 82 to the calculated target image contrast, wherein, as the vehicle 10 moves forward and the image 82 displayed appears painted onto the second road segment 92 within the AR-HUD FOV 86 in front of the vehicle 10, the contrast of the image 82 is adjusted to the calculated target image contrast. If, at block 208, the current image contrast is sufficiently close to the target image contrast, then the method reverts back to block 202.

In an exemplary embodiment, the displaying, with the AR-HUD 64 in communication with the system controller 34A, the image 82 onto the inner surface 66 of the windshield 68 of the vehicle 10, wherein the image 82 appears, to the occupant within the vehicle 10, painted onto the first road segment 84 within the AR-HUD FOV 86 in front of the vehicle 10 at block 202 further includes displaying, with the AR-HUD 64 in communication with the system controller 34A, the image 82 onto the inner surface 66 of the windshield 68 of the vehicle 10, wherein the image 82 appears, to the occupant within the vehicle 10, painted onto the first road segment 84 within the AR-HUD FOV 86 extending from approximately twenty-five meters in front of the vehicle 10 to approximately ninety meters in front of the vehicle 10.

In another exemplary embodiment, the measuring, with the forward-looking camera 52 in communication with the system controller 34A, luminance properties of the second road segment 92 in front of the first road segment 84 beyond the AR-HUD FOV 86 at block 204 further includes, moving to block 212, calculating a distance 100 that the second road segment 92 is spaced in front of the AR-HUD FOV 86 based on system latency, and, moving to block 214, measuring, with the forward-looking camera 52 in communication with the system controller 34A, luminance properties of the second road segment 92 that is spaced the calculated distance 100 in front of the AR-HUD FOV 86, such that as the vehicle 10 moves forward and the image 82 displayed appears, to the occupant, painted onto the second road segment 92 within the AR-HUD FOV 86, the contrast of the image 82 is adjusted to the calculated target image contrast.

In another exemplary embodiment, the measuring, with the forward-looking camera 52 in communication with the system controller 34A, luminance properties of the second road segment 92 in front of the first road segment 84 beyond the AR-HUD FOV 86 at block 204 further includes, moving to block 216, calculating a distance 100 that the second road segment 92 is spaced in front of the AR-HUD FOV 86 based on a speed of the vehicle 10, and, moving to block 214, measuring, with the forward-looking camera 52 in communication with the system controller 34A, luminance properties of the second road segment 92 that is spaced the calculated distance 100 in front of the AR-HUD FOV 86, such that as the vehicle 10 moves forward and the image 82 displayed appears, to the occupant, painted onto the second road segment 92 within the AR-HUD FOV 86, the contrast of the image 82 is adjusted to the calculated target image contrast.

In another exemplary embodiment, the measuring, with the forward-looking camera 52 in communication with the system controller 34A, luminance properties of the second road segment 92 in front of the first road segment 84 beyond the AR-HUD FOV 86 further includes, moving to block 218, calculating a distance 100 that the second road segment 92 is spaced in front of the AR-HUD FOV 86 and a lateral position of the second road segment 92 based on a speed of the vehicle 10 and a trajectory of the vehicle 10, and, moving to block 214, measuring, with the forward-looking camera 52 in communication with the system controller 34A, luminance properties of the second road segment 92 spaced at the calculated distance 100 and lateral position in front of the AR-HUD FOV 86.

In an exemplary embodiment, the calculating the distance 100 that the second road segment 92 is spaced in front of the AR-HUD FOV 86 and a lateral position of the second road segment 92 based on a speed of the vehicle 10 and a trajectory of the vehicle 10 at block 218 further includes receiving, with the system controller 34A, data related to the speed of the vehicle 10 from a speedometer 62 of the vehicle 10, and data related to the trajectory of the vehicle 10 from a navigation system 58 of the vehicle 10 and a position sensor 60 mounted onto a steering wheel of the vehicle 10.

In another exemplary embodiment, the measuring, with the forward-looking camera 52 in communication with the system controller 34A, luminance properties of the second road segment 92 in front of the first road segment 84 beyond the AR-HUD FOV 86 at block 204 further includes, moving to block 220, selecting, from a first look-up-table 104, a pixel map 102 that maps the location of the second road segment 92 relative to the AR-HUD FOV 86 based on a speed of the vehicle 10 and a trajectory of the vehicle 10, wherein the first look-up-table 104 includes a plurality of pixel maps 102 that map the location of the second road segment 92 relative to the AR-HUD FOV 86 at various vehicle speeds and vehicle trajectories, such that as the vehicle 10 moves forward and the image 82 displayed appears, to the occupant, painted onto the second road segment 92 within the AR-HUD FOV 86, the contrast of the image 82 is adjusted to the calculated target image contrast, and, moving to block 222, measuring, with the forward-looking camera 52 in communication with the system controller 34A, luminance properties of the second road segment 92 based on the selected pixel map 102.

In another exemplary embodiment, the adjusting the contrast of the image 82 to the calculated target image contrast, wherein, as the vehicle 10 moves forward and the image 82 displayed appears painted onto the second road segment 92 within the AR-HUD FOV 86 in front of the vehicle 10, the contrast of the image 82 is adjusted to the calculated target image contrast at block 210 further includes adjusting the contrast of the image 82 by adjusting, individually, each pixel within the image 82, such that the displayed image 82 appears, to the occupant, at the calculated target contrast, across the entire image 82, when luminance properties vary across the second road segment 92.

In another exemplary embodiment, the calculating, with the system controller 34A, a target image contrast for the image 82 based on the measured luminance properties of the second road segment 92 at block 206 further includes selecting, from a second look-up-table 106, the calculated target image contrast based on the measured luminance properties of the second road segment 92, wherein the second look-up-table 106 includes a plurality of calculated target image contrast values for various luminance properties of the second road segment 92.

In another exemplary embodiment, the adjusting the contrast of the image 82 to the calculated target image contrast, wherein, as the vehicle 10 moves forward and the image 82 displayed appears painted onto the second road segment 92 within the AR-HUD FOV 86 in front of the vehicle 10, the contrast of the image 82 is adjusted to the calculated target image contrast at block 210 further includes gradually adjusting the contrast of the image 82 to the calculated target image.

In another exemplary embodiment, the adjusting the contrast of the image 82 to the calculated target image contrast, wherein, as the vehicle 10 moves forward and the image 82 displayed appears painted onto the second road segment 92 within the AR-HUD FOV 86 in front of the vehicle 10, the contrast of the image 82 is adjusted to the calculated target image contrast at block 210 further includes dampening contrast adjustments as the vehicle travels through alternating conditions.

In another exemplary embodiment, the measuring, with the forward-looking camera 52 in communication with the system controller 34A, luminance properties of the second road segment 92 in front of the first road segment 84 beyond the AR-HUD FOV 86 at block 204 further includes measuring, with the forward-looking camera 52, chromatic properties of the second road segment 92, and, the adjusting the contrast of the image 82 to the calculated target image contrast at block 210 further includes adjusting chromatic properties of the image 82 based on the chromatic properties of the second road segment 92.

In another exemplary embodiment, the method 200 further includes, moving from block 210 to block 224, monitoring, with the occupant monitoring system 54, the occupant's eyes 70, wherein, at block 226, if dilation/constriction of the pupils of the occupant indicate that the occupant is struggling to adapt to the brightness of the image 82, then the method reverts back to block 206, wherein the calculating, with the system controller 34A, a target image contrast for the image 82 based on the measured luminance properties of the second road segment 92 further includes calculating, with the system controller 34A, a target image contrast for the image based on the measured luminance properties of the second road segment 92 and pupil characteristics of the eyes of the occupant. If at block 226, the occupant monitoring system 54 does not detect dilation/constriction of the pupils of the occupant, then the method 200 reverts back to block 202 without further adjustment of the target image contrast value.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of controlling luminance contrast of an image displayed by an augmented reality head-up-display (AR-HUD) within a vehicle, comprising:
displaying, with an AR-HUD in communication with a system controller, an image onto an inner surface of a windshield of the vehicle, wherein the image appears, to an occupant within the vehicle, painted onto a first road segment within an AR-HUD field of view (FOV) in front of the vehicle;
measuring, with a forward-looking camera in communication with the system controller, luminance properties of a second road segment in front of the first road segment beyond the AR-HUD FOV;
calculating, with the system controller, a target image luminance contrast for the image based on the measured luminance properties of the second road segment; and
adjusting the brightness of the image to meet the calculated target image luminance contrast, wherein, as the vehicle moves forward and the image displayed appears painted onto the second road segment within the AR-HUD FOV in front of the vehicle, the brightness of the image is adjusted to meet the calculated target image luminance contrast.

2. The method of claim 1, wherein the displaying, with the AR-HUD in communication with the system controller, the image onto the inner surface of the windshield of the vehicle, wherein the image appears, to the occupant within the vehicle, painted onto the first road segment within the AR-HUD FOV in front of the vehicle further includes:
displaying, with the AR-HUD in communication with the system controller, the image onto the inner surface of the windshield of the vehicle, wherein the image appears, to the occupant within the vehicle, painted onto the first road segment within the AR-HUD FOV extending from approximately twenty-five meters in front of the vehicle to approximately ninety meters in front of the vehicle.

3. The method of claim 1, wherein the measuring, with the forward-looking camera in communication with the system controller, luminance properties of the second road segment in front of the first road segment beyond the AR-HUD FOV further includes:
calculating a distance that the second road segment is spaced in front of the AR-HUD FOV based on system latency; and
measuring, with the forward-looking camera in communication with the system controller, luminance properties of the second road segment that is spaced the calculated distance in front of the AR-HUD FOV, such that as the vehicle moves forward and the image displayed appears, to the occupant, painted onto the second road segment within the AR-HUD FOV, the brightness of the image is adjusted to meet the calculated target image luminance contrast.

4. The method of claim 1, wherein the measuring, with the forward-looking camera in communication with the system controller, luminance properties of the second road segment in front of the first road segment beyond the AR-HUD FOV further includes:
calculating a distance that the second road segment is spaced in front of the AR-HUD FOV based on a speed of the vehicle; and
measuring, with the forward-looking camera in communication with the system controller, luminance properties of the second road segment that is spaced the calculated distance in front of the AR-HUD FOV, such that as the vehicle moves forward and the image displayed appears, to the occupant, painted onto the second road segment within the AR-HUD FOV, the brightness of the image is adjusted to the calculated target image contrast.

5. The method of claim 1, wherein the measuring, with the forward-looking camera in communication with the system controller, luminance properties of the second road segment in front of the first road segment beyond the AR-HUD FOV further includes:
calculating a distance that the second road segment is spaced in front of the AR-HUD FOV and a lateral position of the second road segment based on a speed of the vehicle and a trajectory of the vehicle; and
measuring, with the forward-looking camera in communication with the system controller, luminance properties of the second road segment spaced at the calculated distance and lateral position in front of the AR-HUD FOV.

6. The method of claim 5, wherein the calculating a distance that the second road segment is spaced in front of the AR-HUD FOV and a lateral position of the second road segment based on a speed of the vehicle and a trajectory of the vehicle further includes receiving, with the system controller, data related to the speed of the vehicle from a speedometer of the vehicle, and data related to the trajectory of the vehicle from a navigation system of the vehicle and a steering angle sensor of the vehicle.

7. The method of claim 1, wherein the measuring, with the forward-looking camera in communication with the system controller, luminance properties of the second road segment in front of the first road segment beyond the AR-HUD FOV further includes:
selecting, from a first look-up-table, a pixel map that maps the location of the second road segment relative to the AR-HUD FOV based on a speed of the vehicle and a trajectory of the vehicle, wherein the first look-up-table includes a plurality of pixel maps that map the location of the second road segment relative to the AR-HUD FOV at various vehicle speeds and vehicle trajectories, such that as the vehicle moves forward and the image displayed appears, to the occupant, painted onto the second road segment within the AR-HUD FOV, the brightness of the image is adjusted to meet the calculated target image luminance contrast; and
measuring, with the forward-looking camera in communication with the system controller, luminance properties of the second road segment based on the selected pixel map.

8. The method of claim 1, wherein the adjusting the luminance contrast of the image to the calculated target image contrast, wherein, as the vehicle moves forward and the image displayed appears painted onto the second road segment within the AR-HUD FOV in front of the vehicle, the brightness of the image is adjusted to meet the calculated target image luminance contrast further includes:
adjusting the brightness of the image by adjusting, individually, each pixel within the image, such that the displayed image appears, to the occupant, at the calculated target luminance contrast, across the entire image, when luminance properties vary across the second road segment.

9. The method of claim 1, wherein the calculating, with the system controller, a target image luminance contrast for the image based on the measured luminance properties of the second road segment further includes:
selecting, from a second look-up-table, the calculated target image luminance contrast based on the measured luminance properties of the second road segment, wherein the second look-up-table includes a plurality of calculated target image luminance contrast values for various luminance properties of the second road segment.

10. The method of claim 1, wherein the adjusting the brightness of the image to meet the calculated target image luminance contrast, wherein, as the vehicle moves forward and the image displayed appears painted onto the second road segment within the AR-HUD FOV in front of the vehicle, the brightness of the image is adjusted to the calculated target image luminance contrast further includes gradually adjusting the brightness of the image to the calculated target image.

11. The method of claim 1, wherein the adjusting the brightness of the image to the calculated target image luminance contrast, wherein, as the vehicle moves forward and the image displayed appears painted onto the second road segment within the AR-HUD FOV in front of the vehicle, the brightness of the image is adjusted to the calculated target image luminance contrast further includes dampening brightness adjustments as the vehicle travels through alternating conditions.

12. The method of claim 1, wherein:
the measuring, with the forward-looking camera in communication with the system controller, luminance properties of the second road segment in front of the first road segment beyond the AR-HUD FOV further includes measuring, with the forward-looking camera, chromatic properties of the second road segment; and
the adjusting the brightness of the image to meet the calculated target image luminance contrast, wherein, as the vehicle moves forward and the image displayed appears painted onto the second road segment within the AR-HUD FOV in front of the vehicle, the contrast of the image is adjusted to the calculated target image luminance contrast further includes adjusting chromatic properties of the image based on the chromatic properties of the second road segment.

13. The method of claim 1, further including:
monitoring, with an occupant monitoring system, the occupant's eyes;
wherein, the calculating, with the system controller, a target image luminance contrast for the image based on the measured luminance properties of the second road segment further includes calculating, with the system controller, a target image luminance contrast for the image based on the measured luminance properties of the second road segment and pupil characteristics of the eyes of the occupant.

14. A system for controlling luminance of an image displayed by an augmented reality head up display (AR-HUD) for a vehicle, comprising:
an AR-HUD in communication with a system controller and adapted to display an image onto an inner surface of a windshield of the vehicle, wherein the image appears, to an occupant within the vehicle, painted onto a first road segment within an AR-HUD field of view (FOV) that extends from approximately twenty-five meters in front of the vehicle to approximately ninety meters in front of the vehicle; and
a forward-looking camera in communication with the system controller and adapted to measure luminance properties of a second road segment in front of the first road segment beyond the AR-HUD FOV;
the system controller adapted to:
calculate a target image luminance contrast for the image based on the measured luminance properties of the second road segment; and
adjust the brightness of the image to meet the calculated target image luminance contrast, wherein, as the vehicle moves forward and the image displayed appears painted onto the second road segment within the AR-HUD FOV in front of the vehicle, the brightness of the image is adjusted to meet the calculated target image luminance contrast.

15. The system of claim 14, wherein the system controller is adapted to:
receive data related to a speed of the vehicle from a speedometer within the vehicle, and data related to the trajectory of the vehicle from a navigation system of the vehicle and a steering position sensor of the vehicle; and
calculate a distance that the second road segment is spaced in front of the AR-HUD FOV and a lateral position of the second road segment based on at least one of system latency, vehicle speed or vehicle trajectory.

16. The system of claim 15, wherein the system controller is further adapted to:
select, from a first look-up-table stored therein, a pixel map that maps the location of the second road segment relative to the AR-HUD FOV based on a speed of the vehicle and a trajectory of the vehicle, wherein the look-up-table includes a plurality of pixel maps that map the location of the second road segment relative to the AR-HUD FOV at various vehicle speeds and vehicle trajectories; and
select, from a look-up-table stored therein, the calculated target image luminance contrast based on the measured luminance properties of the second road segment, wherein the second look-up-table includes a plurality of calculated target image luminance contrast values for various luminance properties of the second road segment.

17. The system of claim 16, wherein the system controller is adapted to adjust the brightness of the image by adjusting, individually, each pixel within the image, such that the displayed image appears, to the occupant, at the calculated target image luminance contrast, across the entire image, when luminance properties vary across the second road segment.

18. The system of claim 17, wherein the system controller is further adapted to:
gradually adjusting the brightness of the image to meet the calculated target image luminance contrast;
dampen brightness adjustments as the vehicle travels through alternating conditions; and
measure, with the forward-looking camera, chromatic properties of the second road segment and adjust chromatic properties of the image based on the chromatic properties of the second road segment.

19. The system of claim 18, further including an occupant monitoring system adapted to monitor the eyes of the occupant, wherein, the system controller is further adapted to calculate the target image luminance contrast for the image based on the measured luminance properties of the second road segment and pupil characteristics of the eyes of the occupant.

20. A vehicle having a system for controlling luminance contrast of an image displayed by an augmented reality head up display (AR-HUD), the system comprising:
an AR-HUD in communication with a system controller and adapted to display an image onto an inner surface of a windshield of the vehicle, wherein the image appears, to an occupant within the vehicle, painted onto a first road segment within an AR-HUD field of view (FOV) that extends from approximately twenty-five meters in front of the vehicle to approximately ninety meters in front of the vehicle; and
a forward-looking camera in communication with the system controller and adapted to measure luminance properties of a second road segment in front of the first road segment beyond the AR-HUD FOV;
the system controller adapted to:
receive data related to a speed of the vehicle from a speedometer within the vehicle, and data related to the trajectory of the vehicle from a navigation system of the vehicle and a steering position sensor of the vehicle;
select, from a first look-up-table stored therein, a pixel map that maps the location of the second road segment relative to the AR-HUD FOV based on a speed of the vehicle and a trajectory of the vehicle, wherein the look-up-table includes a plurality of pixel maps that map the location of the second road segment relative to the AR-HUD FOV at various vehicle speeds and vehicle trajectories;
select, from a look-up-table stored therein, a calculated target image luminance contrast based on the measured luminance properties of the second road segment, wherein the second look-up-table includes a plurality of calculated target image luminance contrast values for various luminance properties of the second road segment; and
adjust, individually, each pixel within the image, such that the displayed image appears, to the occupant, at the calculated target luminance contrast, across the entire image, when luminance properties vary across the second road segment, wherein, as the vehicle moves forward and the image displayed appears painted onto the second road segment within the AR-HUD FOV in front of the vehicle, the contrast of the image is adjusted to the calculated target image luminance contrast.
